(19) United States
(12) Patent Application Publication
(10) Pub. No.: US 2008/0193203 A1
(43) Pub. Date: Aug. 14, 2008

(54) Fitting for a vehicle seat

(75) Inventors: Heinz Voss, Leverkusen (DE); Ulrich Lehmann, Alfter (DE); Grit Scholz, Remscheid (DE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: KEIPER GmbH & Co. KG, Kaiserslautern (DE)

(21) Appl. No.: 12/148,090

(22) Filed: Apr. 16, 2008

Related U.S. Application Data
(63) Continuation of application No. PCT/EP2006/010551, filed on Nov. 3, 2006.

(30) Foreign Application Priority Data
Nov. 16, 2005 (DE) 10 2005 054 489.4

(51) Int. Cl. F16C 11/00

(52) U.S. Cl. 403/97

(57) ABSTRACT

A first fitting part is in geared connection with a second fitting part, and a rotatably mounted eccentric drives a rolling movement of the first and second fitting parts on each other. The eccentric includes at least one driver and wedge segments. The components of the eccentric bear at least indirectly by way of their inner side and/or their outer side in each case against one of the fitting parts, at least one component of the eccentric is mounted with its inner side on the first fitting part and/or with its outer side on the second fitting part and interacts directly with the relevant fitting part, wherein the component of the eccentric or the associated fitting part, in the interacting region, is coated with a thin layer, and the thin layer has a lower coefficient of friction than the material of the component.

### CROSS-REFERENCE TO RELATED APPLICATION

The present application is a continuation of International Application PCT/EP2006/010551, which was filed Nov. 3, 2006. The entire disclosure of International Application PCT/EP2006/010551, which was filed Nov. 3, 2006, is incorporated herein by reference.

### TECHNICAL FIELD

The present invention relates to a fitting for a vehicle seat, in particular a fitting for a motor vehicle seat, with the fitting having a first fitting part; a second fitting part in geared connection with the first fitting part; and a multi-part eccentric that is rotatably mounted in the first fitting part and is intended for driving a rolling movement of first fitting part and second fitting part on each other, with the components of the eccentric including at least one driver and wedge segments, wherein for the mounting of the eccentric, the components of the eccentric bear at least indirectly by way of their inner side and/or their outer side in each case against one of the fitting parts, and at least one component of the eccentric is mounted with its inner side on the first fitting part and/or with its outer side on the second fitting part and interacting directly with the relevant fitting part.

### BACKGROUND OF THE INVENTION

DE 44 36 101 A1 discloses a fitting of the type mentioned above, in the Technical Field section of this disclosure. In the fitting known from DE 44 36 101 A1, the wedge segments sit radially on the inside directly on a collar formation of the first fitting part, and the wedge segments bear radially on the outside against a sliding bearing. The sliding bearing is designed as a sliding bearing bushing that is pressed into the second fitting part. The static friction radially on the inside, on account of the material pairing of steel on steel, contributes to the reliability of movement of the fitting. When the fitting is driven, the wedge segments move with low sliding friction along the sliding bearing of the second fitting part. In the case of a further fitting of this type, which is known from DE 199 38 666 A1 and has a driver of two-part design, the wedge segments sit on a driving ring of the driver, with the driving ring in turn being mounted on the collar formation.

### BRIEF SUMMARY OF SOME ASPECTS OF THE INVENTION

An aspect of the present invention is the provision of improvements for a fitting of the type mentioned above, in the Technical Field section of this disclosure. In accordance with one aspect of the present invention, a fitting for a vehicle seat, in particular a fitting for a motor vehicle seat, has a first fitting part; a second fitting part in geared connection with the first fitting part; and a multi-part eccentric that is rotatably mounted in the first fitting part and is intended for driving a rolling movement of first fitting part and second fitting part on each other, with the components of the eccentric including at least one driver and wedge segments, wherein for the mounting of the eccentric, the components of the eccentric bear at least indirectly by way of their inner side and/or their outer side in each case against one of the fitting parts, and at least one component of the eccentric is mounted with its inner side on the first fitting part and/or with its outer side on the second fitting part and interacting directly with (e.g., bearing directly against) the relevant fitting part, and wherein the component of the eccentric or the associated fitting part, in the interacting region, is coated with a thin layer, and the thin layer has a lower coefficient of friction than the material of the component.

Because a component (of the eccentric) that is mounted on the fitting part is coated on its inner side and/or its outer side, or the associated fitting part, in the region interacting with the component, is coated with a thin layer which has a lower coefficient of friction than the material of the (metallic) component, the friction on two interacting surfaces can be reduced in a specific manner, thus improving the efficiency of the fitting. By way of the (sliding) layer which is formed on a side of the component, which side bears, in a known embodiment, against a pressed-in sliding bearing or rolling bearing, such a low degree of friction is achieved that the pressed-in sliding bearing or rolling bearing may be omitted, i.e. a component is saved and construction space obtained, for example in order to increase the strength. The coated eccentric component or the eccentric component interacting with the coated surface may also be a (preferably metallic) driving ring of a multi-part driver, which driving ring is arranged radially between the wedge segments and the associated fitting part. The wedge segments within the context of the invention do not have to be geometrically genuine segments but rather may also be formed in each case on a disk, with the two (eccentric) disks then being arranged offset axially with respect to each other.

If the layer is used at a location which otherwise has a high degree of friction, for example on the wedge-segment inner side which faces a collar formation, the lower range fluctuation of the coefficient of friction enables the design to be closer to the self-locking limit without impairing the reliability of movement of the self-locking fitting. If the fitting is prevented from running because of other locking elements, the design can go beyond the self-locking limit.

The layer is preferably an amorphous carbon layer. In principle, a diamond layer, because of its extremely high hardness, would ideally protect a stressed surface against wear, but it cannot be produced in a sufficiently smooth manner under industrially expedient process conditions. An amorphous carbon layer is preferably crosslinked tetrahedrically, and therefore it largely exhibits the superhard diamond properties, and, in particular, it can be set to hardnesses of between 40 and 75% of the hardness of diamond, with a very high degree of resistance to abrasive wear being ensured even with respect to ceramic expendable bodies and wear particles. Hardnesses of up to 75 GPa (corresponding to 7500 HV) can be set. In expert circles, these amorphous carbon layers are also referred to as diamond like carbon (DLC) layers.

At the same time, the amorphous carbon layer can be produced industrially on a relatively large scale, for example by way of (laser) pulsed vacuum arc discharge, with homogeneous coatings of ultra-thin layers into the micrometer range being able to be produced. Some of the carbon particles penetrate the surface layer of the support material (subplantation), which ensures a better, in particular more load-bearing, connection between the amorphous carbon layer and the support material than would be the case with simple deposition (condensation), for example of sliding paint or PTFE. The support material has a supporting capability which is matched to the local loading of the amorphous carbon layer in order to use the high degree of hardness of the amorphous carbon layer. Carbon is bio-compatible and physiologically acceptable.

The amorphous carbon layer shows little tendency to adhere to other materials, and therefore a cold pick-up in any desired frictional pairing is avoided and a very low coefficient of friction results, for example in relation to steel, approximately 10 to 15% of the value of a frictional pairing of steel on steel. A further reduction in the friction is possible by way of special lubricating means. All in all, the desired coefficient of friction can therefore be set.

In the case of the arrangement known for geared fittings, with fitting parts and wedge segments in between, the wedge segments should have a higher coefficient of friction toward one fitting part, for example toward a collar formation of the first fitting part, and a lower coefficient of friction toward the other fitting part, with this other fitting part usually being provided with a sliding bearing on a collar formation. The coefficient of friction which can be set permits any desired combinations of uncoated surfaces and amorphous carbon layers which can each be formed on the wedge segments and/or on the interacting region of the associated fitting part, and therefore the sliding bearing may be omitted. The corresponding ratios and advantages arise if, in the case of motor-driven geared fittings, a moveable driving ring is additionally provided, as a component of the eccentric, between the wedge segments and one of the fittings. The amorphous carbon layers are then provided on those sides of the components of the eccentric which face away from each other—and face the fitting parts, and/or on the interacting regions of the associated fitting parts.

The wedge segments (or interacting regions of the fitting parts or else just one single wedge segment) may also have, on the outside and inside (on both sides), a layer with a very low degree of friction, i.e. with a friction in each case significantly below the self-locking limit, which reduces the frictional losses during driving of the fitting, i.e. during the adjustment movement, thus increasing the efficiency of the fitting. A lower driving power is therefore required for the same output power.

Since a wedge segment which is mounted on both sides by way of a small degree of friction is no longer self-locking, and also the fitting would therefore possibly be no longer self-locking, a brake for the wedge segment is preferably provided at least on one side of the vehicle seat. The brake holds the wedge segment in the inoperative state of the fitting, and the brake is released during the driving of the rolling movement. A fitting of this type is both reliable in terms of movement and is also favorable with regard to efficiency. A brake of this type does not need to be provided in the fitting on the other side of the vehicle seat. A preferred brake is a wrap spring brake which supplies a high locking moment on the output side, but, when a torque is introduced on the drive side, rotates with a freewheeling moment which is low in relation to the locking moment. Instead of a wrap spring brake, a clamping roller freewheel may also be provided. The freedom from play and the strength are maintained in each case.

The layer may, however, also be a sliding layer of high-performance plastic, in particular a PEEK (polyetheretherketone) sliding layer, which combines a high resistance to wear with very low coefficients of friction. The partially crystalline sliding layer of high-performance plastic which is highly wear-resistant and for which a layer thickness in the region of fractions of a millimeter (e.g. 0.3 mm) generally suffices, is preferably provided on the outer side of the wedge segments which interact, for example, in a known arrangement with a short collar formation of the second fitting part, with the pressed-in sliding bearing being omitted. The use of a PTFE (polytetrafluoroethylene, Teflon) layer as the sliding layer is likewise possible. Any desired combinations of arrangements of sliding layer or sliding layers of the wedge segments and with the amorphous carbon layer are possible.

The fitting according to the invention is preferably used in a vehicle seat for the adjustment of the inclination of the backrest, but may also be used elsewhere.

Other aspects and advantages of the present invention will become apparent from the following.

### BRIEF DESCRIPTION OF THE DRAWINGS

The invention is explained in more detail below with reference to an exemplary embodiment illustrated in the drawings, in which:

FIG. 1 shows an exploded illustration of the exemplary embodiment,

FIG. 2 shows a partially cutaway, partial view of the exemplary embodiment,

FIG. 3 shows a schematic illustration of a vehicle seat,

FIG. 4 shows a partially cutaway, partial view of a known fitting, and

FIG. 5 shows an exploded illustration of the known fitting.

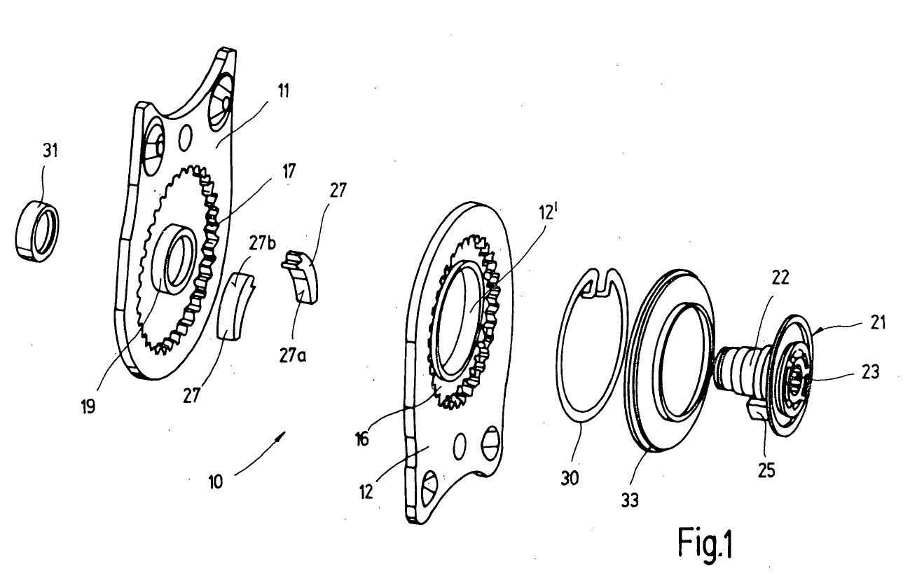

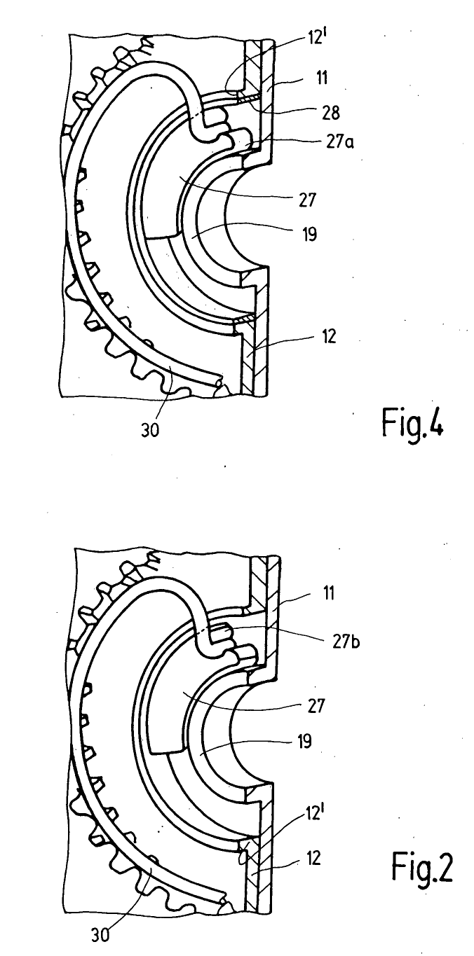

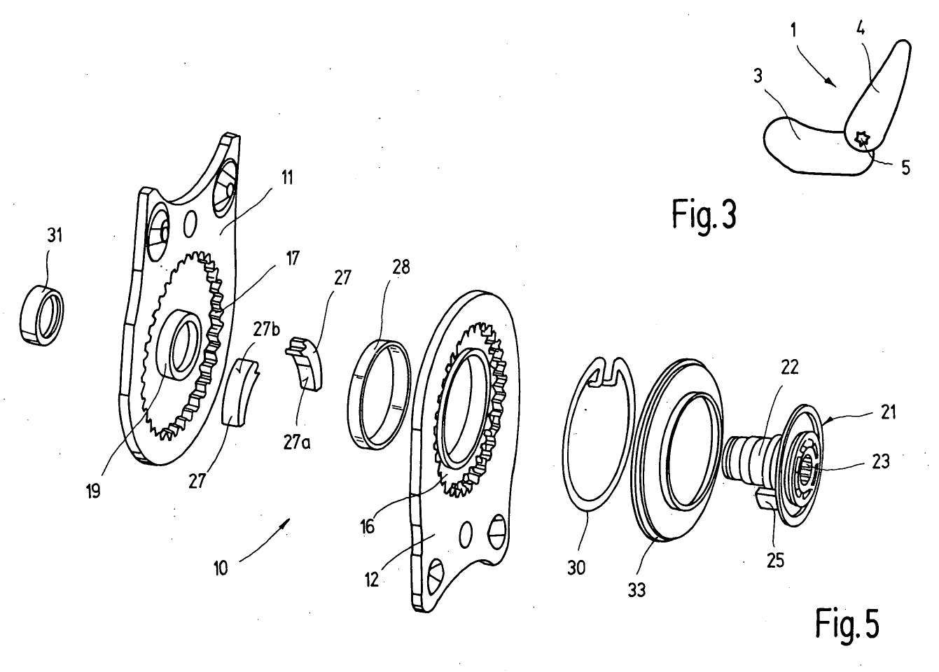

### DETAILED DESCRIPTION OF EXEMPLARY EMBODIMENT

A vehicle seat 1 for a motor vehicle has a seat part 3 and a backrest 4 which can be adjusted in its inclination relative to the seat part 3. A hand wheel 5 is on one side of the vehicle seat 1 and can be actuated manually in order to adjust the inclination. The hand wheel 5 rotates a drive shaft (not shown) which is arranged horizontally in the transition region between seat part 3 and backrest 4. On both sides of the vehicle seat 1, the drive shaft engages in a rotationally fixed manner in a respective fitting 10. The backrest 4 is connected to the seat part 3 by way of the two fittings 10. Of the two illustrated embodiments of the fitting 10, the common features are described first.

The fitting 10 is designed as a geared fitting in which a first fitting part 11 and a second fitting part 12 are connected to each other for adjustment and fixing via a gear designed as an eccentric epicyclic gear (which is preferably self-locking at least in the case of one of the two fittings 10 of the vehicle seat 1). The two fitting parts 11 and 12 are composed of steel and can preferably be hardened in some regions. The two fitting parts 11 and 12 have an essentially (e.g., generally or substantially) flat shape. The first fitting part 11 is connected fixedly to the structure supporting the hand wheel 5 and the drive shaft (in the exemplary embodiment, the structure of the backrest 4), for which reason, in the exemplary embodiment, the first component 11 is illustrated in a manner fixed on the backrest and therefore at the top in the drawing. Accordingly, in the exemplary embodiment, the second fitting part 12 is fixed on the seat part, i.e. is connected to the structure of the seat part 3, and is illustrated at the bottom in the drawing. The positions of the fitting parts 11 and 12 may be interchanged, depending on requirements.

In order to form the gear, a toothed wheel 16 with an outer toothing is embossed on the second fitting part 12, and a toothed ring 17 with an inner toothing is embossed on the first fitting part 11, with the toothings meshing with each other. The diameter of the outside circle of the outer toothing of the toothed wheel 16 is smaller by at least one tooth height than the diameter of the root circle of the inner toothing of the toothed ring 17. The corresponding difference in the number of teeth of toothed wheel 16 and toothed ring 17 permits a rolling movement of the toothed ring 17 on the toothed wheel 16.

On the side facing the toothed wheel 16, the first fitting part 11 has a collar formation 19 concentrically with respect to the inner toothing of the toothed ring 17. The collar formation 19 is an integrally formed component of the first fitting part 11, i.e. is formed as a single piece therewith. A driver 21 is mounted with play in the collar extension 19 by way of a bushing section 22. The driver 21, which is composed of plastic and the arrangement of which defines the direction details used in this disclosure, is provided centrally with a bore 23 which matches the external splines of the drive shaft and extends axially. Furthermore, the driver 21 has an integrally formed driving segment 25 which is arranged in a sickle-shaped manner about part of the collar formation 19. For the mounting on the first fitting part 11, two metallic wedge segments 27 bear, by way of their curved inner sides 27a, directly against the collar formation 19 of the first fitting part 11. For the mounting on the second fitting part 12, the wedge segments 27 bear, by way of their curved outer sides 27b, at least indirectly against the second fitting part 12 which, for this purpose, likewise has an, albeit short, collar formation 12′. The collar formation 12′ is an integrally formed component of the second fitting part 12, i.e. is formed as a single piece therewith. In the exemplary embodiment, the second fitting part 12 supports the wedge segments 27 directly by way of its collar formation 12′, whereas a bushing-shaped sliding bearing 28 which is pressed into the collar formation 12′ is provided for this in the prior art.

The driving segment 25 engages with play between the narrow ends of the wedge segments 27. The mutually facing wide ends of the wedge segments 27 each support an angled end finger of a spring, referred to below as omega spring 30. The omega spring 30 pushes the wedge segments 27 apart in the circumferential direction and therefore positions the fitting 10 in a manner free from play in the inoperative state. The driver 21 is secured axially on the outer side of the first fitting part 11 by way of a securing ring 31 which is clipped on. A sealing ring 33, preferably of rubber, covers the region between the outer side of the second fitting part 12 and a region of the driver 21, with that region of the driver 21 being designed as a covering disk. In order to absorb the axially acting forces, a respective retaining plate (not shown) is welded in a manner known per se onto the two fitting parts 11 and 12 and engages over the other part in each case without obstructing the adjustment movement.

The driving segment 25 and the wedge segments 27 define an eccentric which, as an extension of the direction of eccentricity, presses the toothed wheel 16 and the toothed ring 17 into each other at an engagement point defined in this manner. During driving by way of the rotating drive shaft, a torque is first transmitted to the driver 21 and then to the eccentric which is defined as described above and slides along the inner side of the collar formation 12′, shifting the direction of eccentricity and therefore shifting the engagement point of the toothed wheel 16 in the toothed ring 17, which is exhibited as a wobbling rolling movement of the fitting parts 11 and 12 on each other.

The frictional ratios play an important role both for the locking of the fitting 10 in the inoperative state and for the efficiency during operation. It is known in this case in the prior art that the wedge segments 27 experience a significantly lower degree of friction on their outer side 27b, because of the sliding bearing 28, than on their inner side 27a, and in this regard the opposite variation in friction (frictional ratio) could be provided. According to the exemplary embodiment of the invention, improvements to the frictional ratios are now undertaken/discussed in the following.

The inner side 27a of the wedge segments 27 is coated with a superhard, first amorphous carbon layer, in the exemplary embodiment with a layer thickness in the micrometer range. The amorphous carbon layer integrates the hardness of diamond with low coefficients of friction, with the range of fluctuation of the coefficient of friction being very low. The coefficient of friction of the thin amorphous carbon layer is lower than the coefficient of friction of the material of the wedge segments 27, which are composed essentially of hardened steel or a sintered material. The friction between the wedge segments 27 and the first fitting part 11, i.e. its collar formation 19, can thereby be brought to close to the self-locking limit ensuring locking of the fitting 10. The efficiency of the fitting 10 with this reduced degree of friction can be increased from approximately 0.3 to just under 0.5.

According to the exemplary embodiment of the invention, irrespective of the presence of the first amorphous carbon layer, the outer side 27b of the wedge segments 27 is coated with a second amorphous carbon layer, in the exemplary embodiment with a layer thickness in the micrometer range, the coefficient of friction of which is smaller than that of the first amorphous carbon layer and is set to be approximately at the same level as that of a sliding bearing 28 known from the prior art. As a result, no sliding bearing 28 need be provided, since the direct friction between the wedge segments 27 with the second amorphous carbon layer on the outer side 27b and the second fitting part 12 assumes a very small value. In addition, in the event of a crash, without sliding bearings 28 no plastic deformation of the sliding bearing 28 as the single unhardened component in the force flux can occur. The radial construction space saved by the omission of the sliding bearing 28 can be added to the other components, preferably to the wedge segments 27, and therefore increases the strength of the fitting 10 while the overall construction space remains the same.

Various modifications are possible. The first amorphous carbon layer can be applied to the collar formation 19 of the first fitting part 11 instead of to the wedge segments 27. Given a corresponding setting with a very low degree of friction, the second amorphous carbon layer can be provided directly on the second fitting part 12, also independently of the presence of the first amorphous carbon layer, and therefore in each case a sliding bearing 28 can be omitted. The collar formations 12′ and/or 19 can be hardened.

Modifications are also conceivable, in which the friction between the first fitting part 11 and at least the wedge segment 27 which is subjected to a higher load (because of the weight of the backrest 10) is brought (significantly, under some circumstances) under the self-locking limit by the first amorphous carbon layer, for example by a coating of the relevant wedge segment 27 on both sides or all the way around. The self-locking of the fitting 10 is then to be applied, for example, by way of a switchable brake, for example a wrap spring brake or a clamping roller freewheel.

Finally, modifications are possible in which the driver 21 (in accordance with DE 199 38 666 A1, the entire disclosure of which is expressly incorporated herein by reference) is of multi-part design, i.e. has a driving ring (preferably made of the same material as the wedge segments 27) and a driving bushing made of plastic. The driving ring then has the driving segment 25 and is arranged in the radial direction between the wedge segments 27 and the collar formation 19 of the first fitting part 11 (or in a kinematically reversed modification of the collar formation 12′ of the second fitting part 12), i.e. it bears, on the one hand, against the wedge segments 27 and, on the other hand, against the associated fitting part 11 (or 12). The driving ring as a further component of the eccentric can likewise bear one or both amorphous carbon layers on the inside or outside or on both sides and can interact with correspondingly coated regions of the wedge segments 27 or fitting parts 11 or 12.

It will be understood by those skilled in the art that while the present invention has been discussed above with reference to an exemplary embodiment and modifications thereof, various additions, modifications and changes can be made thereto without departing from the spirit and scope of the invention as set forth in the claims.

That which is claimed:

1. A fitting for a vehicle seat, the fitting comprising:
a first fitting part;
a second fitting part in geared connection with the first fitting part; and
an eccentric that is rotatably mounted in the fitting for driving a rolling movement between the first and second fitting parts;
wherein the eccentric includes components, and the components of the eccentric include at least one driver and wedge segments;
wherein for each component of the group consisting of the driver and the wedge segments, the component includes opposite inner and outer sides, and at least one of the inner and outer sides of the component bears at least indirectly against at least one of the first and second fitting parts; and
wherein for at least one component selected from the group consisting of the driver and the wedge segments
(a) at least a region of the inner side of the component bears directly against a region of the first fitting part,
(b) at least a region of the outer side of the component bears directly against a region of the second fitting part,
(c) or any combination of (a) and (b); and
wherein at least one of the regions is coated with a thin layer, so that the coated region comprises the thin layer, and the thin layer has a lower coefficient of friction than material of the at least one component.

2. The fitting as claimed in claim 1, wherein:
the first fitting part includes an integrally formed component;
the integrally formed component of the first fitting part includes the region of the first fitting part;
the second fitting part includes an integrally formed component; and
the integrally formed component of the second fitting part includes the region of the second fitting part.

3. The fitting as claimed in claim 2, wherein:
the coated region is a first coated region;
at least a second of the regions is coated with a thin layer, so that the second coated region comprises the thin layer of the second coated region; and
the thin layer of the second coated region has a lower coefficient of friction than material of the at least one component.

4. The fitting as claimed in claim 1, wherein the thin layer is an amorphous carbon layer.

5. The fitting as claimed in claim 4, wherein the amorphous carbon layer has a thickness that is within micrometer range or less.

6. The fitting as claimed in claim 1, wherein:
the coated region is a first coated region;
at least a second of the regions is coated with a thin layer, so that the second coated region comprises the thin layer of the second coated region, and the thin layer of the second coated region has a lower coefficient of friction than material of the at least one component;
the thin layer of the first coated region is an amorphous carbon layer; and
the thin layer of the second coated region is an amorphous carbon layer.

7. The fitting as claimed in claim 6, wherein the amorphous carbon layer of the first coated region has a different coefficient of friction than the amorphous carbon layer of the second coated region.

8. The fitting as claimed in claim 1, wherein:
the driver is a multi-part driver that includes a driving ring;
the driving ring is a component of the eccentric;
the driving ring bears against the wedge segments; and
the driving ring bears against at least one of the first and second fitting parts.

9. The fitting as claimed in claim 1, wherein except for any of the thin layer, the wedge segments consist essentially of hardened steel or a sintered material.

10. The fitting as claimed in one of the preceding claims, wherein the thin layer is a sliding layer of high-performance plastic, a PEEK sliding layer, a PTFE sliding layer, or any combination thereof.

11. The fitting as claimed in claim 1 in combination with the vehicle seat, wherein:
the vehicle seat includes a seat part and a backrest;
the backrest is attached to the seat part at a side of the vehicle seat by way of the fitting; and
the fitting is operative so that inclination of the backrest is adjustable at least by way of the fitting.

12. The fitting as claimed in claim 2, wherein:
the integrally formed component of the first fitting part is a collar formation of the first fitting part; and
the integrally formed component of the second fitting part is a collar formation of the second fitting part.

13. The fitting as claimed in claim 3, wherein:
the first coated region is the region of the inner side of the component; and
the second coated region is the region of the outer side of the component.

14. The fitting as claimed in claim 3, wherein:
the first coated region is the region of the first fitting part; and
the second coated region is the region of the second fitting part.

15. The fitting as claimed in claim 4, wherein the amorphous carbon layer is crosslinked tetrahedrically.

16. The fitting as claimed in claim 6, wherein:
the first coated region is the region of the inner side of the component; and
the second coated region is the region of the outer side of the component.

17. The fitting as claimed in claim 6, wherein:
the first coated region is the region of the first fitting part; and
the second coated region is the region of the second fitting part.

18. The fitting as claimed in claim 1, wherein:
the coated region is a first coated region;
at least a second of the regions is coated with a thin layer, so that the second coated region comprises the thin layer of the second coated region, and the thin layer of the second coated region has a lower coefficient of friction than material of the at least one component; and
the thin layer of the first coated region has different coefficient of friction than the thin layer of the second coated region.

19. A fitting for a vehicle seat, the fitting comprising:
a first fitting part;
a second fitting part in geared connection with the first fitting part; and
an eccentric that is rotatably mounted in the fitting for driving a rolling movement between the first and second fitting parts, wherein
the eccentric includes at least one wedge segment;
the wedge segment includes opposite inner and outer sides,
the inner side of the wedge segment bears at least indirectly against the first fitting part,
at least a region of the outer side of the wedge segment bears directly against a region of the second fitting part, and
at least one of the regions is coated with a thin layer, so that the coated region comprises the thin layer, and
the thin layer has a lower coefficient of friction than material of the wedge segment.

20. The fitting as claimed in claim 19, wherein the coated region is the region of the outer side of the wedge segment.

21. The fitting as claimed in claim 20, wherein:
at least a region of the inner side of the wedge segment is coated with a thin layer;
the thin layer of the region of the inner side of the wedge segment has a lower coefficient of friction than the material of the wedge segment; and
the thin layer of the region of the outer side of the wedge segment has a lower coefficient of friction than the thin layer of the region of the inner side of the wedge segment.
